(19) United States
(12) Patent Application Publication
(10) Pub. No.: US 2025/0331462 A1
(43) Pub. Date: Oct. 30, 2025

(54) CENTRAL ROW DIVIDER FOR AN AGRICULTURAL HARVESTER

(71) Applicant: CNH Industrial Brasil Ltda., Nova Lima (BR)

(72) Inventors: Joao Augusto Marcolin Lucca, Piracicaba-SP (BR); Esther Maranho, Piracicaba-SP (BR); Daenio Cleodolphi, Piracicaba-SP (BR)

(21) Appl. No.: 19/193,314

(22) Filed: Apr. 29, 2025

(30) Foreign Application Priority Data
Apr. 30, 2024 (BR) 10 2024 008489 6

(51) Int. Cl. A01D 63/04; A01D 34/43; A01D 34/54; A01D 45/10

(52) U.S. Cl. CPC A01D 63/04; A01D 34/43; A01D 34/54; A01D 45/10

(57) ABSTRACT

An agricultural harvester includes a forward frame. The agricultural harvester further includes a first base cutter and a second base cutter supported adjacent to each other in a lateral direction on the forward frame. Moreover, the agricultural harvester includes a central row divider supported on the forward frame, where the central row divider is aligned at least partially between the first and second base cutters along the lateral direction and extends at least partially forward of the first and second base cutters along a fore-aft direction. Additionally, the agricultural harvester includes a central cutter supported at least partially rearward of a forward end of the central row divider and forward of the first and second base cutters along the fore-aft direction, where the central cutter is configured to cut crop guided by the central row divider.

### CROSS-REFERENCE TO RELATED APPLICATION

The present application is based upon and claims the right of priority to Brazilian Patent Application No. 10 2024 008489 6 filed on Apr. 30, 2024, the entirety of which is incorporated by reference herein for all purposes.

### FIELD OF THE INVENTION

The present disclosure relates generally to agricultural harvesters and, more particularly, to agricultural harvesters having a central row divider and related methods for adjusting operation of such agricultural harvesters.

### BACKGROUND OF THE INVENTION

Typically, agricultural harvesters include an assembly of processing equipment for processing harvested crop materials. For instance, a sugarcane harvester typically includes crop dividers for directing sugarcane stalks towards a base cutter assembly configured to sever sugarcane stalks, the severed sugarcane stalks are then conveyed via a feed roller assembly to a chopper assembly that cuts or chops the sugarcane stalks into pieces or billets (e.g., 6 inch cane sections). The processed crop material discharged from the chopper assembly is then directed as a stream of billets and debris into a primary extractor, within which the airborne debris (e.g., dust, dirt, leaves, etc.) is separated from the sugarcane billets. The separated/cleaned billets then fall into an elevator assembly for delivery to an external storage device.

When a harvester is configured to process multiple rows of crop (e.g., sugarcane) at a time, the harvester may have a respective pair of base cutters for each row. However, as the spacing between crop rows decreases, it may be increasingly difficult to guide a crop row to a respective pair of base cutters without plowing over the crop row.

Accordingly, a central row divider for an agricultural harvester, such as for a multi-row sugarcane harvester, and methods for adjusting operation of an agricultural harvester having such a central row divider would be welcomed in the technology.

### BRIEF DESCRIPTION OF THE INVENTION

Aspects and advantages of the invention will be set forth in part in the following description, or may be obvious from the description, or may be learned through practice of the invention.

In one aspect, the present subject matter is directed to an agricultural harvester. The agricultural harvester may include a forward frame. The agricultural harvester may further include a first base cutter and a second base cutter supported on the forward frame, with the first base cutter being adjacent to the second base cutter in a lateral direction. Moreover, the agricultural harvester may include a central row divider supported on the forward frame, where the central row divider may be aligned at least partially between the first and second base cutters along the lateral direction and may extend at least partially forward of the first and second base cutters along a fore-aft direction. Additionally, the agricultural harvester may include a central cutter supported at least partially rearward of a forward end of the central row divider and forward of the first and second base cutters along the fore-aft direction, where the central cutter may be configured to cut crop guided by the central row divider.

In another aspect, the present subject matter is directed to a method for adjusting operation of an agricultural harvester. Particularly, the agricultural harvester may have a forward frame, and a first base cutter and a second base cutter supported adjacent to each other in a lateral direction on the forward frame. The agricultural harvester may further have a central row divider supported on the forward frame, where the central row divider may be aligned at least partially between with the first and second base cutters along the lateral direction and may extend at least partially forward of the first and second base cutters along a fore-aft direction. The method may include receiving, with a computing system, an input associated with a cutting speed for moving a central cutter, where the central cutter may be supported at least partially rearward of a forward end of the central row divider and forward of the first and second base cutters along the fore-aft direction, with the central cutter being configured to cut crop guided by the central row divider. Additionally, the method may include controlling, with the computing system, operation of a drive device for moving the central cutter relative to the central row divider based at least in part on the input.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a side view of one embodiment of an agricultural harvester in accordance with aspects of the present subject matter;

FIG. 2 illustrates a perspective view of a front end of an agricultural harvester in accordance with aspects of the present subject matter;

FIG. 3 illustrates a front view of the front end of the agricultural harvester shown in FIG. 2 in accordance with aspects of the present subject matter;

FIG. 4 illustrates a partial, section view of the front end of the agricultural harvester shown in FIGS. 2 and 3 taken with respect to section line IV-IV in FIG. 3 in accordance with aspects of the present subject matter, with some parts removed for visibility purposes;

FIG. 5 illustrates a section view of a central row divider of the agricultural harvester shown in FIGS. 2-4 taken with respect to section line V-V in FIG. 4 in accordance with aspects of the present subject matter;

FIG. 6 illustrates a perspective view of the central row divider shown in FIGS. 2-5 in accordance with aspects of the present subject matter;

FIG. 7 illustrates a schematic view of a system for adjusting operation of an agricultural harvester having a central row divider in accordance with aspects of the present subject matter; and

FIG. 8 illustrates a flow diagram of one embodiment of a method for adjusting operation of an agricultural harvester having a central row divider in accordance with aspects of the present subject matter.

Repeat use of reference characters in the present specification and drawings is intended to represent the same or analogous features or elements of the present technology.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield still a further embodiment. Thus, it is intended that the present invention covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to a harvested material within a fluid circuit. For example, “upstream” refers to the direction from which a harvested material flows, and “downstream” refers to the direction to which the harvested material moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

As used herein, a “desired foliage ratio” may be an input that is defined by an operator and/or any device. In addition, a “current foliage ratio” may be a detected foliage ratio of the system while the system is operating.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein will be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a central row divider for an agricultural harvester and methods for adjusting operation of an agricultural harvester having such a central row divider. More particularly, an agricultural harvester configured to harvest multiple crop rows at a time may have multiple pairs of base cutters, where each pair of base cutters is configured to define a crop flow area or “lateral flow region” therebetween for receiving a respective crop row to sever the crop (e.g., sugarcane) and direct such severed crop to a feed roller assembly for further processing. As crop rows are spaced closer and closer together, such as crop rows spaced less than 1.2 meters apart, placing a typical crop row divider (e.g., a crop row divider having a pair of spiral feed rollers) between adjacent crop flow areas to help direct crop rows to their respective crop flow area is not possible, as the typical crop row divider may be too wide to get between the crop rows without plowing some of the crop over.

Thus, a narrow, central row divider is disclosed that overcomes such issue. For instance, the central row divider is supported on the header frame such that it is aligned at least partially between two base cutters along a lateral direction and extends at least partially forward of the two base cutters along a fore-aft direction, where the two base cutters may be associated with different crop flow areas. The central row divider is configured to direct crop towards the first and second base cutters. For instance, the central row divider may easily get between and help gradually separate adjacent crop rows for directing the crop rows towards their respective crop flow areas. Additionally, in accordance with aspects of the present subject matter, a central cutter may be supported at least partially rearward of the central row divider and forward of the first and second base cutters along the fore-aft direction, where the central cutter is configured to cut crop guided by the central row divider. As such, the central cutter may help eliminate knots and tangles intertwining crops of different rows to help direct the rows of crop to the different crop flow areas.

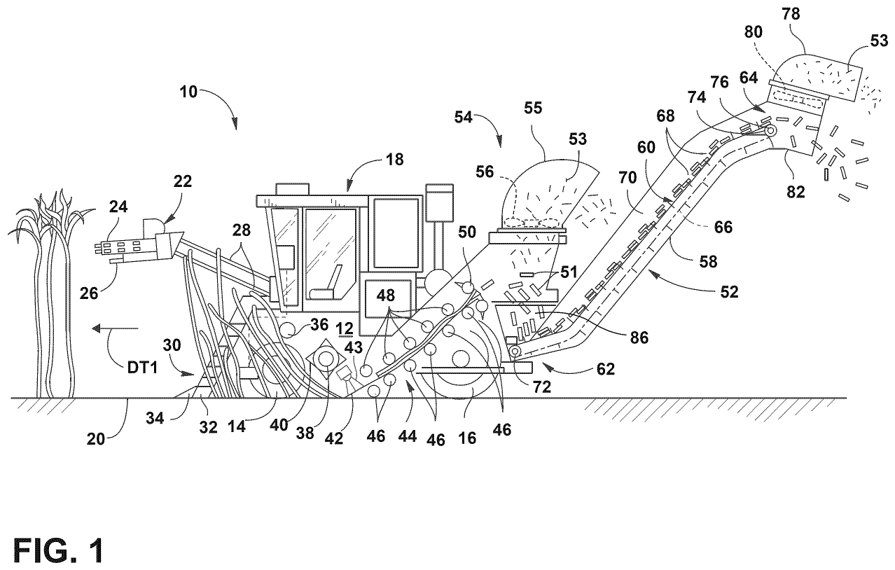

Referring now to the drawings, FIG. 1 illustrates a side view of one embodiment of an agricultural harvester 10 in accordance with aspects of the present subject matter. As shown, the harvester 10 is configured as a sugarcane harvester. However, in other embodiments, the harvester 10 may correspond to any other suitable agricultural harvester known in the art.

As shown in FIG. 1, the harvester 10 includes a frame 12, a pair of front wheels 14, a pair of rear wheels 16, and an operator cab 18. The harvester 10 may also include a primary source of power (e.g., an engine mounted on the frame 12) which drives one or both pairs of the wheels 14, 16 via a transmission (not shown). Alternatively, the harvester 10 may be a track-driven harvester and, thus, may include tracks driven by the engine as opposed to, or in addition to, one or more of the illustrated wheels 14, 16. The engine may also drive a hydraulic fluid pump (not shown) configured to generate pressurized hydraulic fluid for powering various hydraulic components of the harvester 10.

The harvester 10 may include various components for cutting, processing, cleaning, and discharging sugarcane as the cane is harvested from an agricultural field. For instance, during operation, the harvester 10 is traversed across an agricultural field 20 for harvesting crop, such as sugarcane. The harvester 10 may include one or more topper assemblies 22 (only one of which is shown in FIG. 1) positioned at its front end to intercept sugarcane as the harvester 10 is moved in the forward direction of travel DT1. As shown, the topper assembly 22 may include both a gathering disk 24 and a cutting disk 26. As is generally understood, the height of the topper assembly 22 may be adjustable via a pair of arms 28 which may be raised and lowered. After the height of the topper assembly 22 is adjusted via the arms 28, the gathering disk 24 on the topper assembly 22 may function to gather the sugarcane stalks as the harvester 10 proceeds across the field 20, while the cutter disk 26 severs the leafy tops of the sugarcane stalks for disposal along either side of harvester 10.

The harvester 10 may further include lateral crop dividers 30 (only one of which is shown in FIG. 1) that extend upwardly and rearwardly from the field 20. In general, each lateral crop divider 30 may include two spiral feed rollers 32 (only one of which is shown in FIG. 1). Each lateral crop divider 30 may include a ground shoe 34 at its lower end to assist the lateral crop divider 30 in gathering the sugarcane stalks for harvesting. The lateral crop dividers 30 may set the operating width to determine the quantity of sugarcane entering the throat of the harvester 10. The spiral feed rollers 32 then gather the stalks into the throat to allow one or more knock-down rollers 36 to bend the stalks downwardly in conjunction with the action of one or more finned rollers 38. The knock-down roller(s) 36 is positioned near the front wheels 14 and the finned roller(s) 38 is positioned behind or downstream of the knock-down roller(s) 36. As the knock-down roller(s) 36 is rotated, the sugarcane stalks being harvested are knocked down. The finned roller(s) 38 may include a plurality of intermittently mounted fins 40 that assist in forcing the sugarcane stalks further downwardly. For instance, as the finned roller(s) 38 is rotated, the sugarcane stalks that have been knocked down by the knock-down roller(s) 36 are separated and further knocked down by the finned roller(s) 38 as the harvester 10 continues to be moved in the forward direction relative to the field 20.

It should be appreciated that, while each lateral crop divider 30 is described and shown in later figures as having two spiral rollers 32, the lateral crop dividers 30 may include any other suitable number of spiral rollers 32, such as one, three, or more spiral rollers 32 per lateral crop divider 30.

Once the stalks are angled downwardly as shown in FIG. 1, base cutters 42 (only one of which is shown in FIG. 1) may then sever the base of the stalks from field 20. The base cutters 42 are positioned behind or downstream of the finned roller(s) 38. As is generally understood, each base cutter 42 may include knives or blades 43 for severing the sugarcane stalks as the cane is being harvested. The base cutters 42 may be rotated by a hydraulic motor (not shown) powered by the vehicle's hydraulic system. Moreover, in several embodiments, the blades 43 of the base cutters 42 may be angled downwardly to sever the base of the sugarcane as the cane is knocked down by the finned roller(s) 38. Additionally, the height of the base cutters 42 (e.g., of the blades 43) above the field 20 may be adjustable. For instance, it is preferable to sever the sugarcane stalks at or below a particular cutting height above the field 20 such that the maximum amount of sugarcane is harvested during the current harvesting operation and such that the remaining ratoons may regrow during the next growing season. As such, the vertical height of the base cutters 42 may be adjustable to maintain the cutting height for harvesting the sugarcane at or below the particular cutting height.

The severed stalks are then, by movement of the harvester 10, directed to a feed roller assembly 44 located downstream of the base cutters 42 for moving the severed stalks of sugarcane from base cutters 42 along the processing path. As shown in FIG. 1, the feed roller assembly 44 may include a plurality of bottom rollers 46 and a plurality of opposed, top pinch rollers 48. The harvested sugarcane may be pinched between various bottom and top rollers 46, 48 to make the sugarcane stalks more uniform and to convey the harvested sugarcane rearwardly (downstream) during transport. As the sugarcane is transported through the feed roller assembly 44, debris (e.g., rocks, dirt, and/or the like) may be allowed to fall through bottom rollers 46 onto the field 20.

At the downstream end of the feed roller assembly 44 (e.g., adjacent to the rearward-most bottom and top rollers 46, 48), a chopper assembly 50 may cut or chop the compressed sugarcane stalks. In general, the chopper assembly 50 may be used to cut the sugarcane stalks into pieces or “billets” 51, which may be, for example, six (6) inches long. The billets 51 may then be propelled towards an elevator assembly 52 of the harvester 10 for delivery to an external receiver or storage device (not shown).

As is generally understood, a primary extractor assembly 54 may be provided to help separate pieces of debris 53 (e.g., dust, dirt, leaves, etc.) from the sugarcane billets 51 before the billets 51 are received by the elevator assembly 52. The primary extractor assembly 54 is located immediately behind or downstream of the chopper assembly 50 relative to the flow of harvested crop and is oriented to direct the debris 53 outwardly from the harvester 10. The primary extractor assembly 54 may include an extractor fan 56 mounted within a housing 55 for generating a suction force or vacuum sufficient to separate and force the debris 53 through an inlet of the housing 55 into the primary extractor assembly 54 and out of the harvester 10 via an outlet of the housing 55. The separated or cleaned billets 51 are heavier than the debris 53 being expelled through the extractor 54, so the billets 51 may fall downward to the elevator assembly 52 instead of being pulled through the primary extractor assembly 54.

As further shown in FIG. 1, the elevator assembly 52 may include an elevator housing 58 and an elevator 60 extending within the elevator housing 58 between a lower, proximal end 62 and an upper, distal end 64. In general, the elevator 60 may include a looped chain 66 and a plurality of flights or paddles 68 attached to and evenly spaced on the chain 66. The paddles 68 may be configured to hold the sugarcane billets 51 on the elevator 60 as the billets are elevated along a top span of the elevator 70 defined between its proximal and distal ends 62, 64. Additionally, the elevator 60 may include lower and upper sprockets 72, 74 positioned at its proximal and distal ends 62, 64, respectively. As shown in FIG. 1, an elevator motor 76 may be coupled to one of the sprockets (e.g., the upper sprocket 74) for driving the chain 66, thereby allowing the chain 66 and the paddles 68 to travel in an endless loop between the proximal and distal ends 62, 64 of the elevator 60.

Additionally, in some embodiments, pieces of debris or trash 53 (e.g., dust, dirt, leaves, etc.) separated from the elevated sugarcane billets 51 may be expelled from the harvester 10 through a secondary extractor assembly 78 coupled to the rear end of the elevator housing 58. For example, the debris 53 expelled by the secondary extractor assembly 78 may be debris remaining after the billets 51 are cleaned and after debris 53 is expelled by the primary extractor assembly 54. As shown in FIG. 1, the secondary extractor assembly 78 may be located adjacent to the distal end 64 of the elevator 60 and may be oriented to direct the debris 53 outwardly from the harvester 10. Additionally, an extractor fan 80 may be mounted at the base of the secondary extractor assembly 78 for generating a suction force or vacuum sufficient to pick up the debris 53 and force the debris 53 through the secondary extractor assembly 78. The separated, cleaned billets 51, heavier than the debris 53 expelled through the extractor 78, may then fall from the distal end 64 of the elevator 60. Typically, the billets 51 may fall downwardly through an elevator discharge opening 82 of the elevator assembly 52 into an external storage device (not shown), such as a sugarcane billet cart.

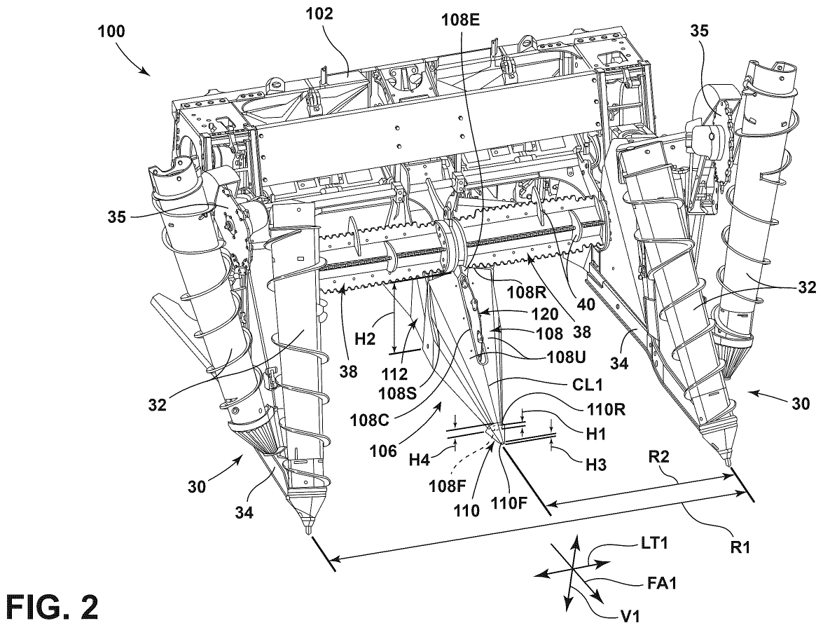

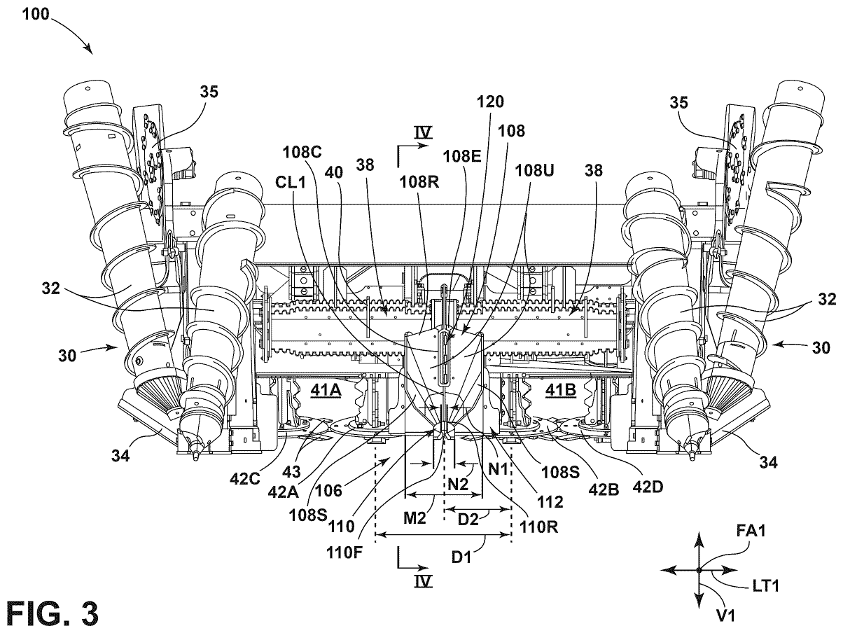

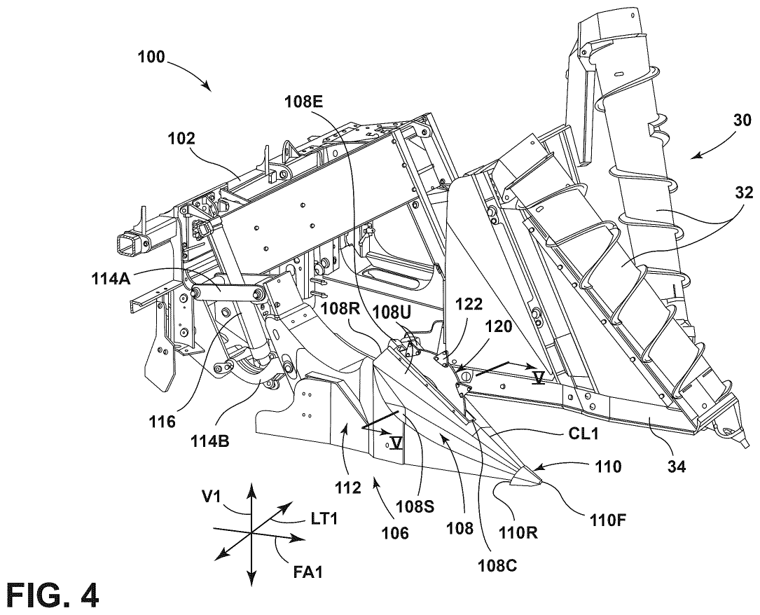

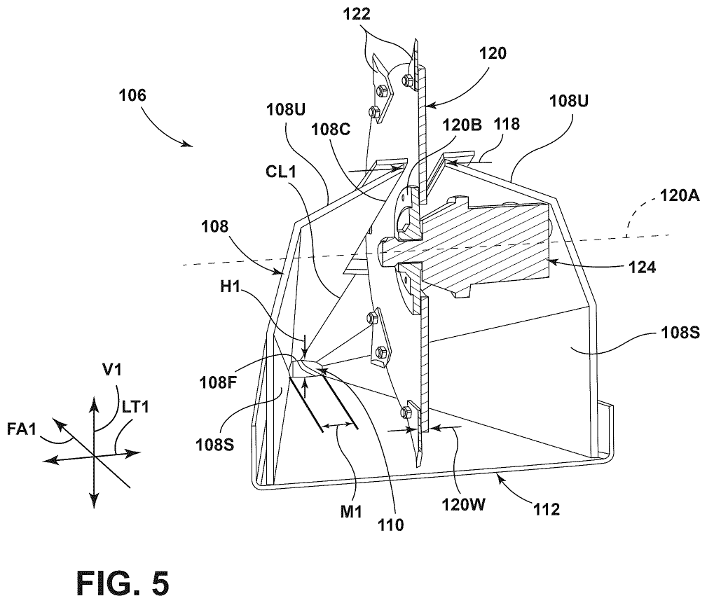

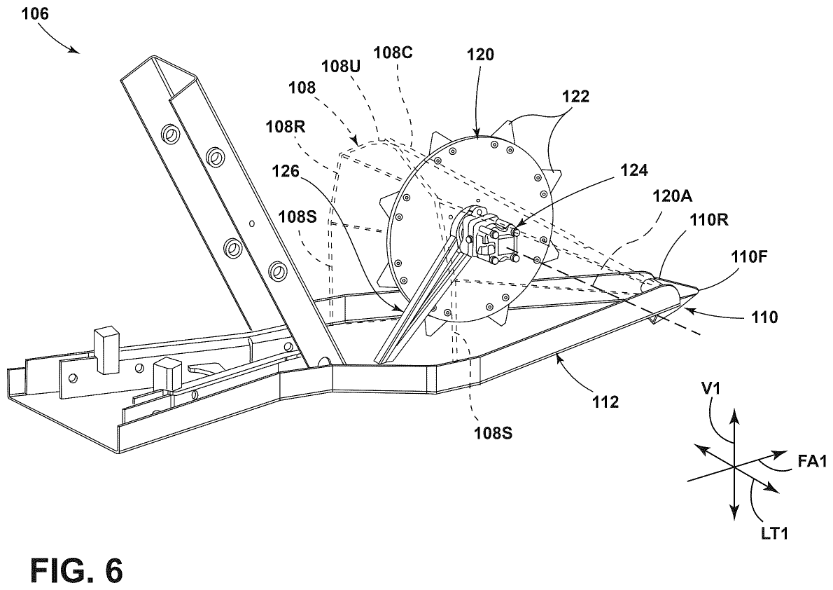

Referring now to FIGS. 2-6, various views of a header 100 suitable for use with a harvester, such as the harvester 10 in FIG. 1, are illustrated in accordance with aspects of the present subject matter. Particularly, FIG. 2 illustrates a perspective view of a front end of the header 100 of the agricultural harvester 10. FIG. 3 illustrates a front view of the front end of the header 100 of the agricultural harvester 10 shown in FIG. 2. FIG. 4 illustrates a partial, section view of the front end of the header 100 of the agricultural harvester 10 shown in FIGS. 2 and 3 taken with respect to section line IV-IV in FIG. 3, with the finned roller(s) 38 and the base cutters 42 removed for visibility purposes. Moreover, FIG. 5 illustrates a section view of a central row divider of the header 100 of the agricultural harvester 10 shown in FIGS. 2-4 taken with respect to section line V-V in FIG. 4. Additionally, FIG. 6 illustrates a perspective view of the central row divider 106 shown in FIGS. 2-5 in accordance with aspects of the present subject matter.

As particularly shown in FIGS. 2-4, the header 100 includes a forward frame 102. In some embodiments, the forward frame 102 is fixed relative to or part of the frame 12 (FIG. 1) of the harvester 10. However, in other embodiments, the forward frame 102 is configured to be supported on the chassis or frame 12 (FIG. 1) of the harvester 10 such that the forward frame 102 is movable relative to the frame 12 (FIG. 1) of the harvester 10. The forward frame 102 may generally support the various components of the harvester 10 relative to the chassis or frame 12 (FIG. 1). For instance, each of the lateral crop dividers 30 (alternatingly referred to as “lateral row dividers 30”) may be coupled proximate a forward end of the forward frame 102 relative to a fore-aft direction FA1 of the agricultural harvester 10. For example, a first lateral row divider 30 is coupled proximate a first lateral side of the forward frame 102 in a lateral direction LT1 and a second lateral row divider is coupled proximate a second lateral side of the forward frame 102 in the lateral direction LT1. As shown in FIG. 2, the lateral row dividers 30 are spaced apart along the lateral direction LT1 of the harvester 10 by a distance R1 to define a feed or throat width of the header 100. In some instances, the crop dividers 30 are movably coupled at the forward end of the forward frame 102. For example, the crop dividers 30 may move up and down in a vertical direction V1 relative to the forward frame 102, together or independently of each other, such as when a shoe member 34 of each divider 30 moves along the surface of the field. In such instance, the lateral crop dividers 30 may include crop divider actuator(s) (not shown) for controlling the movement of the lateral crop dividers 30 relative to the forward frame 102. Moreover, in some instances, the lateral crop dividers 30 may be laterally movable to adjust the distance R1. Additionally, in some instances, each of the lateral crop dividers 30 may be associated with a side trimmer 35 to cut leaves tangled between crop rows being divided.

The finned rollers 38 and the base cutters 42 may also be supported relative to the forward frame 102. For instance, the header 100 is configured as a dual-row header 100 configured to take in two crop rows at a time. For example, as best shown in FIG. 3, the header 100 includes a first pair of base cutters 42 (e.g., first central base cutter 42A and left base cutter 42C) defining a first crop flow region 41A laterally therebetween, and a second pair of base cutters 42 (e.g., second central base cutter 42B and right base cutter 42D) defining a second crop flow region 41B laterally therebetween. As is generally understood, each of the base cutters 42A, 42B, 42C, 42D is rotatably coupled relative to the forward frame 102 such that each of the base cutters 42A, 42B, 42C, 42D is rotatable about a respective rotational axis relative to the forward frame 102. The first and second central base cutters 42A, 42B (e.g., rotational axes of the first and second central base cutters 42A, 42B) are spaced apart by a distance D1 in the lateral direction LT1. The finned rollers 38 are generally positioned forward of the base cutters 42 relative to the fore-aft direction FA1 and above the base cutters 42 relative to the vertical direction V1 and, as shown in FIG. 2, at least partially rearward of the dividers 30 relative to the fore-aft direction FA1. The finned rollers 38 may each rotate relative to the forward frame 102 about a respective rotational axis.

Moreover, as shown in FIGS. 2-4, in accordance with aspects of the present subject matter, the header 100 also includes a central row divider 106. The central row divider 106 is configured to help separate crop rows for direction towards the flow regions 41A, 41B (FIG. 3), particularly for getting between and dividing narrowly spaced crop rows. As such, the central row divider 106 may be aligned at least partially between the flow regions 41A, 41B along the lateral direction LT1 when viewed from the front as in FIG. 3. For instance, in some embodiments, the central row divider 106 is aligned at least partially between the first and second central base cutters 42A, 42B and between the lateral row dividers 30. For example, the central row divider 106 may be spaced apart from at least one of the central base cutters 42A, 42B by a distance D2 (FIG. 3) in the lateral direction LT1 and from at least one of the lateral row dividers 30 by a distance R2 (FIG. 2) in the lateral direction LT1. In some instances, the distance D2 (FIG. 3) is half of the distance D1 (FIG. 3) between the central base cutters 42A, 42B such that the central row divider 106 is centered between the central base cutters 42A, 42B. Similarly, in some instances, the distance R2 (FIG. 2) is half of the distance R1 (FIG. 2) between the lateral row dividers 30 such that the central row divider 106 is centered between the lateral row dividers 30. In one or more embodiments, the central row divider 106 extends at least partially forward of the base cutters 42 and the finned rollers 38 along the fore-aft direction FA1. As will be described in greater detail below, the central row divider 106 may be fixed or movable relative to the forward frame 102.

The central row divider 106 may be shaped to assist in dividing the crop rows. For instance, the central row divider 106 may have a main body portion 108. The main body portion 108 may extend between a front end 108F (FIGS. 2 and 5) and a rear end 108R (FIGS. 2-4 and 6) along the fore-aft direction FA1. The main dividing portion 108 has a width increasing in the lateral direction LT1 from proximate the front end 108F to proximate the rear end 108R along the fore-aft direction FA1. For example, the width at the front end 108F of the main dividing portion 108 is a first width M1 (FIG. 5), whereas the width at the rear end 108R of the main dividing portion 108 is a second width M2 (FIG. 3), where the second width M2 is larger than the first width M1. In some instances, the width of at least a portion of the main dividing portion 108 may continuously increase from proximate the front end 108F to proximate the rear end 108R. For instance, as shown in FIGS. 2-4, the width in the lateral direction LT1 of the upper surface 108U of the main dividing portion 108 continuously increases from proximate the front end 108F to proximate the rear end 108R. In one instance, the width in the lateral direction LT1 of the main dividing portion 108 at the side surfaces 108S continuously increases from proximate the front end 108F to a location only partway between the front and rear ends 108F, 108R (e.g., at the section line 5-5′ in FIG. 4) along the fore-aft direction FA1 and then remains constant (or decrease) from such location to the rear end 108R.

In some instances, the main dividing portion 108 is substantially symmetric about a plane defined by the vertical direction V1 and the fore-aft direction FA1, a line of symmetry or “centerline” CL1 of the main dividing portion 108 extends within such plane. In such instances, the width of the main dividing portion 108 in the lateral direction LT1 may increase substantially equally about the centerline CL1 along the fore-aft direction FA1. In some embodiments, as illustrated, the central row divider 106 may particularly be used without one or more associated spiral feed roller(s) (e.g., like the pairs of spiral feed rollers 32 associated with each of the lateral row dividers 30) to keep the overall width of the central row divider 106 smaller when compared to the width of the lateral row dividers 30.

Moreover, the main dividing portion 108 has a height increasing in the vertical direction V1 from proximate the front end 108F to proximate the rear end 108R. For example, the height of the main dividing portion 108 at the front end 108F is a first height H1 (FIGS. 2 and 5), whereas the height of the main dividing portion 108 at the rear end 108R is a second height H2 (FIG. 2), where the second height H2 is taller than the first height H1. In some instances, the height of at least a portion of the main dividing portion 108 may continuously increase from proximate the front end 108F to proximate the rear end 108R. For instance, as shown in FIGS. 2-4, the height in the vertical direction V1 of the main dividing portion 108 at least at the upper surface 108U continuously increases from proximate the front end 108F to proximate the rear end 108R along the fore-aft direction FA1. Moreover, in some instances, the height in the vertical direction V1 of the main dividing portion 108 at the upper surface 108U increases from the side portions 108S towards the centerline CL1 of the main dividing portion 108. As best shown in FIG. 3, a height range of the main dividing portion 108 in the vertical direction V1 (e.g., represented by the second height H2 in FIG. 2)) at least partially overlaps a height range of the finned rollers 38 in the vertical direction V1, while being at least partially spaced apart along the fore-aft direction FA1 as shown in FIG. 2.

Further, in some embodiments, the central row divider 106 has a nose portion 110. As shown in FIGS. 2-4 and 6, the nose portion 110 may extend between a front end 110F (nose tip) and a rear end 110R (nose end) along the fore-aft direction FA1. The nose portion 110, similar to the main body portion 108, has a nose width increasing in the lateral direction LT1 from proximate the front end 110F to proximate the rear end 110R along the fore-aft direction FA1. For example, the width at the front end 110F of the nose portion 110 is a first width N1 (FIG. 3), whereas the width at the rear end 110R of the nose portion 110 is a second width N2 (FIG. 3), where the second width N2 is larger than the first width N1. In some embodiments, as shown in FIGS. 2-4, the width of the nose portion 110 continuously increases from the front end 110F to the rear end 110R. However, in other instances, similar to the main body portion 108, the width of the nose portion 110 may increase only across some regions between the front end 110F and the rear end 110R, where the regions may be continuous or spaced apart, and where such increases may be constant or varying.

In some instances, the nose portion 110 is substantially symmetric about a plane defined by the vertical direction V1 and the fore-aft direction FA1. In such instances, the width of the nose portion 110 in the lateral direction LT1 may increase substantially equally about the fore-aft direction FA1.

Moreover, the nose portion 110 has a nose height that increases in the vertical direction V1 from proximate the front end 110F to proximate the rear end 110R. For example, the height of the nose portion 110 at the front end 110F is a third height H3 (FIG. 2), whereas the height of the nose portion 110 at the rear end 110R is a fourth height H4 (FIG. 2), where the fourth height H4 is taller than the third height H3. In some instances, the height of at least a portion of the nose portion 110 may continuously increase from proximate the front end 110F to proximate the rear end 110R. For instance, as shown in FIGS. 2-4, the height in the vertical direction V1 of the nose portion 110 continuously increases from the front end 110F to the rear end 110R along the fore-aft direction FA1. Moreover, in some instances, the height in the vertical direction V1 of the nose portion 110 increases from the lateral outward sides towards a center of the nose portion 110 in the lateral direction LT1. Additionally, in some instances, as shown in FIG. 3, the front end 110F of the nose portion 110 may be positioned vertically higher along the vertical direction V1 than the rear end 110R of the nose portion 110, which may help guide the central row divider 106 over the ground surface instead of digging into the ground.

In some instances, the main dividing portion 108 is partially received within the nose portion 110. For instance, as indicated in FIG. 2, the front end 108F of the main dividing portion 108 is received within the nose portion 110. More particularly, the front end 108F of the main dividing portion 108 is positioned forward of the rear end 110R of the nose portion 110 along the fore-aft direction FA1, and the rear end 108R of the main dividing portion 108 is positioned rearward of the rear end 110R of the nose portion 110 along the fore-aft direction FA1. In some embodiments, the planes of symmetry of the main body portion 108 and the nose portion 110 may be aligned (e.g., co-planar). The nose portion 110 may at least partially protect the main dividing portion 108 against wear, where the nose portion 110 may be configured to be more frequently replaceable than the main dividing portion 108. As such, the nose portion 110 may be couplable to the main dividing portion (e.g., via screws, pins, rivets, and/or the like). However, it should be appreciated that, in other embodiments, the main dividing portion 108 is used without a separate nose portion 110. For instance, the main dividing portion 108 may have, proximate the front end 108F, one or more of the features of the nose portion 110.

Moreover, in some embodiments, the central row divider 106 has a shoe portion 112. The shoe portion 112 may be configured similar to the ground shoes 34 (FIG. 1) of the lateral row dividers 30 in that the shoe portion 112 may help the central row divider 106 move along the surface of the field. For instance, the main dividing portion 108 may be coupled to the shoe portion 112. For example, as best shown in FIG. 5, in some instances the main dividing portion 108 may be at least partially received within the shoe portion 112 such that the main dividing portion 108 does not ride directly along the surface of the field. In some instances, the main dividing portion 108 is coupled to the shoe portion 112 such that the dividing portion 108 is positioned entirely forward of the finned rollers 38 as shown in FIG. 2. In such instances, at least a portion of the finned rollers 38 may extend above part of the shoe portion 112 in the vertical direction V1. In some instances, the front end 108F of the main dividing portion 108 and a front end of the shoe portion 112 are both received within the nose portion 110.

In some embodiments, as indicated above, the central row divider 106 may be movably supported on the forward frame 102. For instance, in one embodiment, as shown in FIG. 4, the central row divider 106 is movably coupled on the forward frame 102 by a parallel linkage including a first link 114A and a second link 114B. In some embodiments, the parallel linkage is coupled between the forward frame 102 and the shoe portion 112. For instance, in one embodiment, the parallel linkage may be coupled between the forward frame 102 and the shoe portion 112 at a location at least partially rearward of the main dividing portion 108. The parallel linkage may allow the central row divider 106 to move up and down with the contour of the surface of the field as the harvester 10 moves across a field. It should be appreciated that, in some embodiments, the parallel linkage may be adjustable such that the angle of attack of the central row divider 106 relative to the forward frame 102, and thus, the position of the front end 110F of the nose portion 110 relative to the rear end 108R of the main dividing portion 108 in the vertical direction V1, may additionally be adjusted.

In some embodiments, one or more row divider actuators 116 may be provided for controlling the movement of the central row divider 106 relative to the forward frame 102. For instance, the row divider actuator(s) 116 may be coupled proximate one end to the forward frame 102 and proximate another end to the parallel linkage (e.g., to one of the links 114A, 114B). As such, adjustment of the length of the row divider actuator(s) 116 may adjust the position of the central row divider 106 to help keep the central row divider 106 in proper engagement with the surface of the field.

Additionally, in accordance with aspects of the present subject matter, a central cutter 120 may be provided in association with the central row divider 106 as shown in FIGS. 2-6. For instance, the central cutter 120 may be configured to cut crop guided by the central row divider 106, such as to cut through tangles or knots between tips of crop in adjacent rows being divided by the central row divider 106. As such, the central cutter 120 may be supported at least partially rearward of the forward end of the central row divider 106 and forward of the base cutters 42 along the fore-aft direction FA1.

In some embodiments, the central cutter 120 is a disk having one or more blades 122 or serrations spaced apart about its periphery for cutting the crop divided by the central row divider 106. In such embodiments, as best shown in FIGS. 5 and 6, the central cutter 120 is rotatably supported relative to the central row divider 106 such that the central cutter 120 may rotate about an axis 120A relative to the central row divider 106. Moreover, a central cutter drive device 124 may be provided in association with the central cutter 120, where the central cutter drive device 124 may be controllable to rotate the central cutter 120 about the axis 120A relative to the central row divider 106. In some instances, the central cutter drive device 124 is hydraulically driven (e.g., by the hydraulic fluid pump driven by the engine of the harvester 10). However, in other embodiments, the central cutter drive device 124 is driven in any other suitable way. For instance, the central cutter drive device 124 may be configured as an electric motor and electrically driven.

In some embodiments, as shown in FIG. 6, a support arm 126 is provided for supporting the central cutter 120 and/or the central cutter drive device 124 relative to the central row divider 106. For instance, the support arm 126 may support the central cutter 120 for rotation relative to the central row divider 106 about the axis 120A and/or the central cutter drive device 124 against rotation relative to central row divider 106. For instance, in some embodiments, the support arm 126 is rotatably coupled proximate a first end to the central cutter 120 (e.g., to an optional hub 120B of the central cutter 120 at the rotational axis 120A) for allowing the central cutter 120 to rotate about the rotational axis 120A. In some instances, the support arm 126 is additionally, or alternatively, fixedly coupled proximate the first end to the central cutter drive device 124. Moreover, the support arm 126 is fixedly coupled proximate a second end, opposite the first end, to the central row divider 106 (e.g., to the shoe portion 112) for supporting the central cutter 120 relative to the central row divider 106 such that the axis 120A is fixed relative to the central row divider 106 and/or for supporting a housing of the central cutter drive device 124 in a fixed position relative to the central row divider 106.

Such support arm 126 may make it easier to install the central cutter 120 and/or the central cutter drive device 124 relative to the central row divider 106. For instance, as the central row divider 106 may be narrow, the central cutter 120 and/or the central cutter drive device 124 may be coupled proximate the first end of the support arm 126 before the support arm 126 is coupled proximate its second end to the central row divider 106. However, it should be appreciated that, in some instances, the housing of the central cutter drive device 124 may be fixedly couplable to the central row divider 106 (e.g., to the main dividing portion 108) such that the central row divider 106 rotationally supports the central cutter 120 relative to the central row divider 106, without, or in addition to the support arm 126.

In one or more embodiments, the central row divider 106 may define a cutout or opening 108C through which the central cutter 120 may at least partially extend. For example, in some instances, the main dividing portion 108 at least partially defines the opening 108C through which the central cutter 120 may at least partially extend. The opening 108C, in one or more instances, is at least partially defined in the upper surface 108U of the main dividing portion 108. In some embodiments, the opening 108C may extend in the fore-aft direction FA1 along (e.g., parallel to) the centerline CL1 of the main dividing portion 108. In one embodiment, the opening 108C opens to the rear end 108R of the main dividing portion 108. In such embodiment, the central row divider 106 may include an end housing piece 108E couplable at the rear end 108R of the main dividing portion 108 to define a portion of the opening 108C such that the opening 108C is at least partially enclosed at the rear end 108R of the main dividing portion 108 by the end housing piece 108E. In some instances, the end housing piece 108E fully encloses the opening 108C at the rear end 108R of the main dividing portion 108. However, in some instances, the opening 108C is fully defined by the main dividing portion 108, with the opening 108C being fully encircled by the main dividing portion 108 such that the opening 108C does not open to the rear end 108R of the main dividing portion 108 and the end housing piece 108E is not needed. A width 118 (FIG. 5) of the opening 108C in the lateral direction LT1 may be wider than a width 120W of the central cutter 120 in the lateral direction LT1, such that the central cutter 120 may be received, and rotate, in the opening 108C without interference by the main dividing portion 108.

Generally, the central cutter 120 is supported relative to the central row divider 106 such that the central cutter 120 extends at least partially above the central row divider 106 (and the opening 108C) in the vertical direction V1 so that the central cutter 120 may cut the crop being divided by the central row divider 106. For example, in the illustrated embodiments, the rotational axis 120A of the central cutter 120 is positioned within the central row divider 106 such that the central cutter 120 extends only partially above the central row divider 106 in the vertical direction V1 to prevent crop from tangling with the central cutter drive device 124. In such instances, the central cutter drive device 124 may also be at least partially positioned within the central row divider 106 (e.g., within the main dividing portion 108). For example, in one or more instances, the central cutter drive device 124 may be entirely positioned within the central row divider 106 (e.g., within the main dividing portion 108), aside from links for controlling such central cutter drive device 124 (if necessary). However, in some instances, the support arm 126 extends through the opening 108C such that the central cutter 120 is positioned entirely above the central row divider 106 in the vertical direction V1. In such instances, the central cutter drive device 124 may also be positioned above the central row divider 106 in the vertical direction V1.

It should be appreciated that the central cutter 120 may be configured in any other suitable way, such as a chainsaw chain, a reciprocating saw. Accordingly, it should be appreciated that the central cutter drive device 124 may also be configured in any other suitable manner. For instance, the central cutter 120 may alternatively, or additionally, be configured to slide along the fore-aft direction FA1 and/or the lateral direction LT1 relative to the central row divider 106. Additionally, it should be appreciated that, while only one central cutter 120 is shown as being associated with the central row divider 106, multiple central cutters 120 may provided in association with the central row divider 106. For instance, multiple central cutters 120 may be configured to rotate about the same rotational axis 120A and/or about further rotational axes spaced apart along at least the fore-aft direction FA1.

It should be appreciated that, while the header 100 is shown and described in FIGS. 2-6 as being a dual-row header, the header 100 may alternatively be configured to process any suitable, multiple number of rows, such as three, four, or more rows, such that the header 100 would correspondingly include three, four or more pairs of base cutters 42 and two, three, or more central row dividers 106.

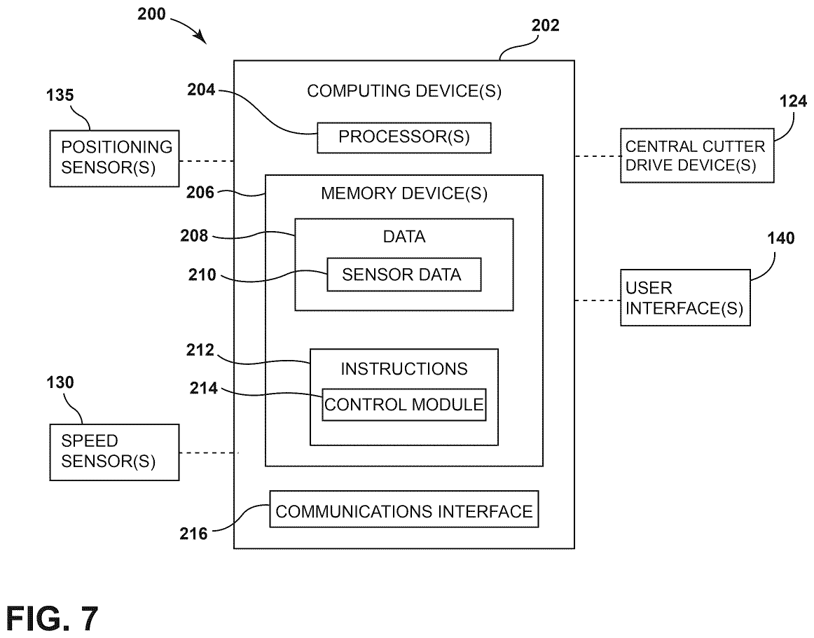

Referring now to FIG. 7, a schematic view of a system 200 for adjusting operation of an agricultural harvester having a central row divider is illustrated in accordance with aspects of the present subject matter. In general, the system 200 will be described with reference to the agricultural harvester 10 described with reference to FIG. 1 having the central row divider 106 described with reference to FIGS. 2-6. However, it should be appreciated that the disclosed system 200 may be implemented with harvesters having any other suitable configurations.

In several embodiments, the system 200 may include one or more computing devices 202 and various other components configured to be communicatively coupled to and/or controlled by the computing device(s) 202, such as the central cutter drive device(s) 124, one or more sensors 130 for generating sensor data indicative of a ground speed of the agricultural harvester 10, one or more positioning sensors 135 for detecting a location of the agricultural harvester 10 within a field, and/or one or more user interfaces 140. It should be appreciated that the positioning sensor(s) 135 described herein may include, without limitation, a satellite navigation position system (e.g. a GPS, a Galileo positioning system, a Global Navigation satellite system (GLONASS), a BeiDou Satellite Navigation and Positioning system, and/or the like), and/or a dead reckoning device, which may generate data (e.g., coordinates) indicative of an exact location of the agricultural harvester 10. Moreover, it should be appreciated that the user interface(s) 140 described herein may include, without limitation, any combination of input and/or output devices that allow an operator to provide inputs to the computing device(s) 202 and/or that allow the computing device(s) 202 to provide feedback to the operator, such as a keyboard, keypad, pointing device, buttons, knobs, touch sensitive screen, mobile device, audio input device, audio output device, and/or the like.

In general, the computing device(s) 202 may correspond to any suitable processor-based device(s), such as a computing device or any combination of computing devices. Thus, as shown in FIG. 7, the computing device(s) 202 may generally include one or more processor(s) 204 and associated memory devices 206 configured to perform a variety of computer-implemented functions (e.g., performing the methods, steps, algorithms, calculations and the like disclosed herein). As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 206 may generally comprise memory element(s) including, but not limited to, computer readable medium (e.g., random access memory (RAM)), computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 206 may generally be configured to store information accessible to the processor(s) 204, including data 208 that can be retrieved, manipulated, created and/or stored by the processor(s) 204 and instructions 212 that can be executed by the processor(s) 204.

In several embodiments, the data 208 may be stored in one or more databases. For example, the memory 206 may include a sensor database 210 for storing data generated by the sensor(s) 130, 135. The speed sensor(s) 130 may be configured as any suitable speed sensor configured to generate data indicative of the ground speed of the agricultural harvester 10. For example, in some embodiments, the speed sensor(s) 130 may be configured as a rotary speed sensor(s) configured to monitor the rotational speed of a given component that provides an indication of the ground speed of the harvester 10, such as the rotational speed of a component of the engine or the transmission of the agricultural harvester 10, a wheel of the agricultural harvester 10, and/or the like. In one or more embodiments, the speed sensor(s) 130 may additionally, or alternatively, be configured as an optical sensor (e.g., a camera, a radio detection and ranging (RADAR) sensor, and/or the like) having a field of view directed towards the field to generate data indicative of the ground speed of the harvester 10, where such speed sensor(s) 130 may be positioned on the harvester 10. In some instances, the speed sensor(s) 130 may correspond to a GPS device or any other suitable satellite navigation position system configured to generate data associated with the ground speed of the harvester 10. For instance, the speed sensor(s) 130 may be one or more of the positioning sensor(s) 135. The data stored within the database 210 may be geo-referenced or may otherwise be stored with corresponding location data associated with the specific location at which such data was collected within the field, such as based on the data from the positioning sensor(s) 135.

Referring still to FIG. 7, in several embodiments, the instructions 212 stored within the memory 206 of the computing device(s) 202 may be executed by the processor(s) 204 to implement a control module 214. In general, the control module 214 may be configured to analyze the sensor data 210 to determine a ground speed of the harvester 10. For instance, in embodiments where the speed sensor(s) 130 includes rotary speed sensor(s), the rotational speed of a component of the harvester 10 may be monitored based on the data generated by the rotary speed sensor(s) 130, where the rotational speed of the component may be correlated to the ground speed of the harvester 10 (e.g., based on established relationships). Similarly, when the speed sensor(s) 130 includes optical sensor(s), the data generated by the optical sensor(s) 130 may be monitored to determine the ground speed of the harvester 10 and optionally, a density of upcoming crop to be harvested when the field of view of the optical sensor(s) 130 includes upcoming crop. Moreover, when the speed sensor(s) 130 includes positioning sensors (e.g., like positioning sensor(s) 130), the position data generated by the speed sensor(s) 130 may be monitored over time to determine the ground speed of the harvester 10. The computing device(s) 202 (e.g., the control module 214) may be configured to analyze the sensor data 210 using any suitable relationships, algorithms, and/or processing techniques (e.g., image processing techniques) to determine the ground speed of the harvester 10 from the sensor data 210.

The control module 214 may be configured to perform a control action based at least in part on an input associated with a cutting speed for moving the central cutter(s) 120 relative to the central row divider(s) 106. For instance, in some embodiments, the input associated with the cutting speed is the sensor data 210 indicative of the cutting speed, where the control action may be configured to control (e.g., automatically) an operation (e.g., actuation) of the central cutter drive device(s) 124 based at least in part on the ground speed of the harvester 10 to adjust a cutting speed of the central cutter(s) 120 relative to the central row divider(s) 106. The control module 214 may, for instance, control the operation of the central cutter drive device(s) 124 to drive the central cutter 120 at a cutting speed (e.g., rotational speed about the rotational axis 120A) associated with the ground speed of the harvester 10. As an example, the control module 214 may control the operation of the central cutter drive device(s) 124 to increase a cutting speed (e.g., rotational speed about the rotational axis 120A) of the central cutter 120 when the ground speed of the harvester 10 increases. Conversely, the control module 214 may control the operation of the central cutter drive device(s) 124 to decrease a cutting speed (e.g., rotational speed about the rotational axis 120A) of the central cutter 120 when the ground speed of the harvester 10 decreases. The control action may additionally, or alternatively, include automatically controlling an operation of the user interface(s) 140 to generally indicate the cutting speed and/or the ground speed, suggest a new cutting speed, and/or the like.

In some embodiments, the input associated with the cutting speed is additionally, or alternatively, a user input received via the user interface(s) 140. For instance, the user input may request a particular cutting speed or may provide information that is indicative of a desired cutting speed, such as a general indication of crop density, a type of crop being harvested, and/or the like. In such instances, the control module 214 may control the operation of the central cutter drive device(s) 124 based on the user input to drive the central cutter(s) 120 at the desired cutting speed.

Referring still to FIG. 7, the computing device(s) 202 may also include a communications interface 216 to provide a means for the computing device(s) 202 to communicate with any of the various system components described herein. For instance, one or more communicative links or interfaces (e.g., one or more data buses) may be provided between the communications interface 216 and the sensor(s) 130, 135 to allow data generated by the sensor(s) 130, 135 to be received by the computing device(s) 202. Additionally, one or more communicative links or interfaces (e.g., one or more data buses) may be provided between the communications interface 216 and any system components configured to carry out one or more of the elements of the disclosed method. For example, as illustrated, the computing device(s) 202 may be communicatively coupled via one or more communicative links or interface(s) to the central cutter drive device(s) 124, and the user interface(s) 140.

It should be appreciated that the computing device(s) 202 may correspond to an existing controller of the harvester 10. For instance, the computing device(s) 202 may correspond to a harvester controller of the harvester 10. However, the computing device(s) 202 may also correspond to a controller of one or more remote control devices separate from the harvester 10, such as part of a base station local to the field or part of a remote cloud-based computing system located remote to the field.

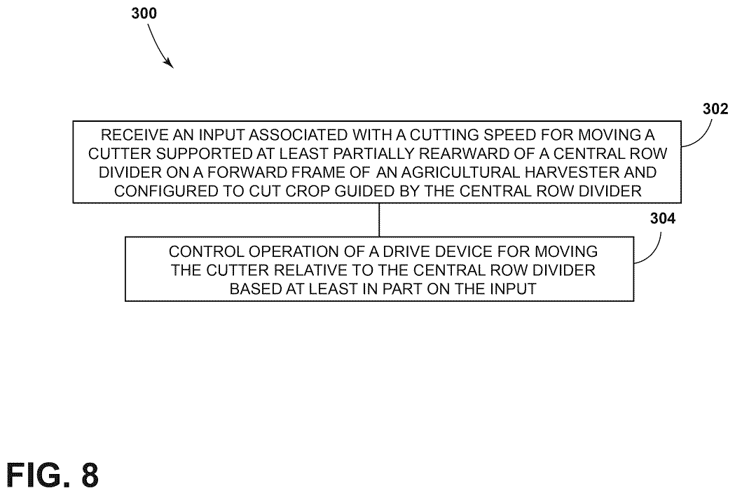

Referring now to FIG. 8, a flow diagram of one embodiment of a method 300 for adjusting operation of an agricultural harvester having a central row divider is illustrated in accordance with aspects of the present subject matter. In general, the method 300 will be described with reference to the agricultural harvester 10 described with reference to FIG. 1 and having the central row divider 106 described with reference to FIGS. 2-6, and the system 200 described with reference to FIG. 7. However, it should be appreciated that the disclosed method 300 may be implemented with harvesters having any other suitable configurations and/or with systems having any other suitable system configurations. In addition, although FIG. 8 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 8, at (302), the method 300 may include receiving an input associated with a cutting speed for moving a cutter supported at least partially rearward of a central row divider on a forward frame of an agricultural harvester and configured to cut crop guided by the central row divider. For instance, as discussed above, the computing device(s) 202 may receive an input associated with the cutting speed for moving the central cutter 120 supported at least partially rearward of the central row divider 106 relative to the forward frame 102 of the agricultural harvester 10, where the central cutter 120 is configured to cut crop guided by the central row divider 106. The computing device(s) 202 may particularly receive the input associated with the cutting speed from the sensor(s) 130, 135 and/or via the user interface(s) 140.

Additionally, at (304), the method 300 may include controlling operation of a drive device for moving the cutter relative to the central row divider based at least in part on the input. For example, as discussed above, the computing device(s) 202 may control the operation of the central cutter drive device(s) 124 for moving the central cutter 120 relative to the central row divider 106 based at least in part on the input. For instance, the computing device(s) 202 may automatically control the operation of the central cutter drive device(s) 124 based at least in part on the ground speed of the agricultural harvester 10 and/or may control the operation of the central cutter drive device(s) 124 based at least in part on the user input.

It is to be understood that the steps of the method 300 are performed by the computing system 200 upon loading and executing software code or instructions which are tangibly stored on a tangible computer readable medium, such as on a magnetic medium, e.g., a computer hard drive, an optical medium, e.g., an optical disk, solid-state memory, e.g., flash memory, or other storage media known in the art. Thus, any of the functionality performed by the computing system 200 described herein, such as the method 300, is implemented in software code or instructions which are tangibly stored on a tangible computer readable medium. The computing system 200 loads the software code or instructions via a direct interface with the computer readable medium or via a wired and/or wireless network. Upon loading and executing such software code or instructions by the computing system 200, the computing system 200 may perform any of the functionality of the computing system 200 described herein, including any steps of the method 300 described herein.

The term “software code” or “code” used herein refers to any instructions or set of instructions that influence the operation of a computer or computing system. They may exist in a computer-executable form, such as machine code, which is the set of instructions and data directly executed by a computer's central processing unit or by a computing system, a human-understandable form, such as source code, which may be compiled in order to be executed by a computer's central processing unit or by a computing system, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a computing system.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An agricultural harvester, comprising:
a forward frame;
a first base cutter and a second base cutter supported on the forward frame, the first base cutter being adjacent to the second base cutter in a lateral direction;
a central row divider supported on the forward frame, the central row divider being aligned at least partially between the first and second base cutters along the lateral direction and extending at least partially forward of the first and second base cutters along a fore-aft direction; and
a central cutter supported at least partially rearward of a forward end of the central row divider and forward of the first and second base cutters along the fore-aft direction, the central cutter being configured to cut crop guided by the central row divider.

2. The agricultural harvester of claim 1, wherein the central row divider is centered between the first and second base cutters along the lateral direction.

3. The agricultural harvester of claim 1, wherein the central row divider comprises a main dividing portion, the main dividing portion having a width increasing in the lateral direction from proximate a front end of the main dividing portion to proximate a rear end of the main dividing portion along the fore-aft direction, the main dividing portion having a height increasing in a vertical direction from proximate the front end to proximate the rear end, the main dividing portion defining an opening, the central cutter extending at least partially through the opening.

4. The agricultural harvester of claim 3, wherein the central cutter extends at least partially above the central row divider in the vertical direction.

5. The agricultural harvester of claim 3, wherein the main dividing portion is symmetric about a plane defined by the vertical direction and the fore-aft direction.

6. The agricultural harvester of claim 3, wherein the central row divider further comprises a shoe portion, the main dividing portion being coupled to the shoe portion, the shoe portion being movable relative to the forward frame.

7. The agricultural harvester of claim 6, further comprising a support arm coupled proximate a first end to the central cutter and proximate a second end to the shoe portion for supporting the central cutter relative to the central row divider.

8. The agricultural harvester of claim 3, further comprising a finned roller rotatably supported on the forward frame, the finned roller extending at least partially forward of the first and second base cutters along the fore-aft direction,
wherein the main dividing portion is positioned forward of the finned roller along the fore-aft direction.

9. The agricultural harvester of claim 1, wherein the central cutter is configured to rotate relative to the central row divider about a rotational axis.

10. The agricultural harvester of claim 9, wherein the rotational axis of the central cutter is fixed relative to the central row divider.

11. The agricultural harvester of claim 1, further comprising a cutter drive device, the cutter drive device being controllable to move the central cutter relative to the central row divider.

12. The agricultural harvester of claim 11, further comprising a computing system, the computing system being configured to control operation of the cutter drive device to move the central cutter relative to the central row divider.

13. The agricultural harvester of claim 1, further comprising a first row divider supported proximate a first lateral side of the forward frame and a second row divider supported proximate a second lateral side of the forward frame, the first row divider and the second row divider each extending at least partially forward of the first and second base cutters along the fore-aft direction, the first row divider and the second row divider being configured to direct crop towards the first and second base cutters,
wherein the central row divider is between the first row divider and the second row divider in the lateral direction.

14. The agricultural harvester of claim 1, further comprising:
a third base cutter supported on the forward frame, the third base cutter being directly adjacent the first base cutter in the lateral direction, the first and third base cutters being configured to direct crop towards a first lateral flow region defined between the first and third base cutters, and
a fourth base cutter supported on the forward frame, the fourth base cutter being directly adjacent the second base cutter in the lateral direction, the second and fourth base cutters being configured to direct crop towards a second lateral flow region defined between the second and fourth base cutters, the first and second lateral flow regions being spaced apart along the lateral direction,
wherein the central row divider is at least partially between the first and second lateral flow regions along the lateral direction.

15. The agricultural harvester of claim 1, wherein the forward frame is part of, fixed relative to, or movable relative to a chassis of the agricultural harvester.

16. A method for adjusting operation of an agricultural harvester, the agricultural harvester comprising a forward frame, a first base cutter and a second base cutter supported adjacent to each other in a lateral direction on the forward frame, a central row divider supported on the forward frame, the central row divider being aligned at least partially between with the first and second base cutters along the lateral direction and extending at least partially forward of the first and second base cutters along a fore-aft direction, the method comprising:
receiving, with a computing system, an input associated with a cutting speed for moving a central cutter, the central cutter being supported at least partially rearward of a forward end of the central row divider and forward of the first and second base cutters along the fore-aft direction, the central cutter being configured to cut crop guided by the central row divider; and
controlling, with the computing system, operation of a drive device for moving the central cutter relative to the central row divider based at least in part on the input.

17. The method of claim 16, wherein receiving the input comprises receiving the input via a user interface.

18. The method of claim 16, wherein receiving the input comprises receiving data generated by a sensor and indicative of a ground speed of the agricultural harvester, the cutting speed corresponding to the ground speed of the agricultural harvester.
